(19) United States
(12) Patent Application Publication
(10) Pub. No.: US 2002/0141146 A1
(43) Pub. Date: Oct. 3, 2002

(54) Computer

(76) Inventor: Colin Mustoe, Blackburn (GB)

Correspondence Address: Jodi-Ann McLane, Salter & Michaelson, 321 South Main Street, Providence, RI, 02903-7128, US

(21) Appl. No.: 10/054,037

(22) Filed: Jan. 22, 2002

(30) Foreign Application Priority Data
Jan. 19, 2001 (GB) 0101379.6

(51) Int. Cl. G06F 1/16

(52) U.S. Cl. 361/683; 361/681

(57) ABSTRACT

A computer having a base having a keyboard and a display arrangement including first and second displays with respective screens, the displays being pivotally connected to the base. The pivotal connections enables the screens to be pivoted from a closed, stored position, in which they are aligned with the base, and an open position is which the screens face away from each other to provide a person other than the computer operator with a screen display.

### 1. TECHNICAL FIELD

The present invention relates to a computer having a display arrangement and particularly, but not exclusively, to a portable computer having such an arrangement.

### 2. BACKGROUND OF RELATED ART

Portable computers such as laptops are frequently used to give demonstrations to customers, associates, and the like. The screen of the display on the conventional laptop is directional. As the users line of sight departs from a direction normal to the screen, the screen becomes increasingly less clear and, therefore, more difficult to read. As a result, it is difficult for both the operator and the customer or associate to have a clear view of the screen which adversely affects the demonstration being given.

### SUMMARY

According to the present invention, there is provided a computer having a base, a display arrangement comprising first and second displays, having respective screens and means for pivotally connecting the displays together and to the base, the means for pivotally connecting being arranged to permit the displays to be pivoted from a closed position in which the associated screens are protected by the base to an open position in which the screens face away from each other.

In a preferred embodiment of the invention, the means for pivotally connecting comprises hinges connecting the displays to each other and to the base. The hinges are advantageously disposed between adjacent edges of the first and second displays and between another edge of the first display and one edge of the base. The hinges between the adjacent edges of the first and second displays are such as to permit the displays to adopt an inverted V-shape together when in the operative, as opposed to the closed or stored position. The hinges may be at the apex of the ‘V’ or between the ends of the legs of the V. These hinges, when at the apex of the ‘V’, are such as to permit the second display to be rotated through more than half a rotation, or less than half a rotation, to bring it into line with the first display. In the latter case a protective cover may be provided to cover the screen of the second display when in the closed or stored position. This protective cover may be pivotally connected to the second display and may provide a support for the displays in the open or operative position.

### BRIEF DESCRIPTION OF THE DRAWINGS

It should be understood that the drawings are provided for the purpose of illustration only and are not intended to define the limits of the invention. The foregoing and other objects and advantages of the embodiments described herein will become apparent with reference to the following detailed description when taken in conjunction with the accompanying drawings in which:

FIG. 1a diagrammatically shows a prior art, conventional laptop computer in the closed position;

FIG. 1b diagrammatically shows the prior art laptop of FIG. 1a in the open position;

FIG. 2 diagrammatically shows in perspective view a laptop computer incorporating a display according to a first embodiment of the present invention;

FIG. 3 diagrammatically shows in perspective view the computer of FIG. 2 in a closed position;

FIG. 4a diagrammatically shows a second embodiment of the laptop computer having a display in a closed position;

FIG. 4b diagrammatically shows a second embodiment of the laptop computer having a display in an open position;

FIG. 5a diagrammatically shows a third embodiment of the laptop computer having a display in a closed position;

FIG. 5b diagrammatically shows a third embodiment of the laptop computer having a display in an open position;

FIG. 6a diagrammatically shows a fourth embodiment of the laptop computer having a display in a closed position; and

FIG. 6b diagrammatically shows a fourth embodiment of the laptop computer having a display in an open position.

### DETAILED DESCRIPTION OF THE ILLUSTRATIVE EMBODIMENTS

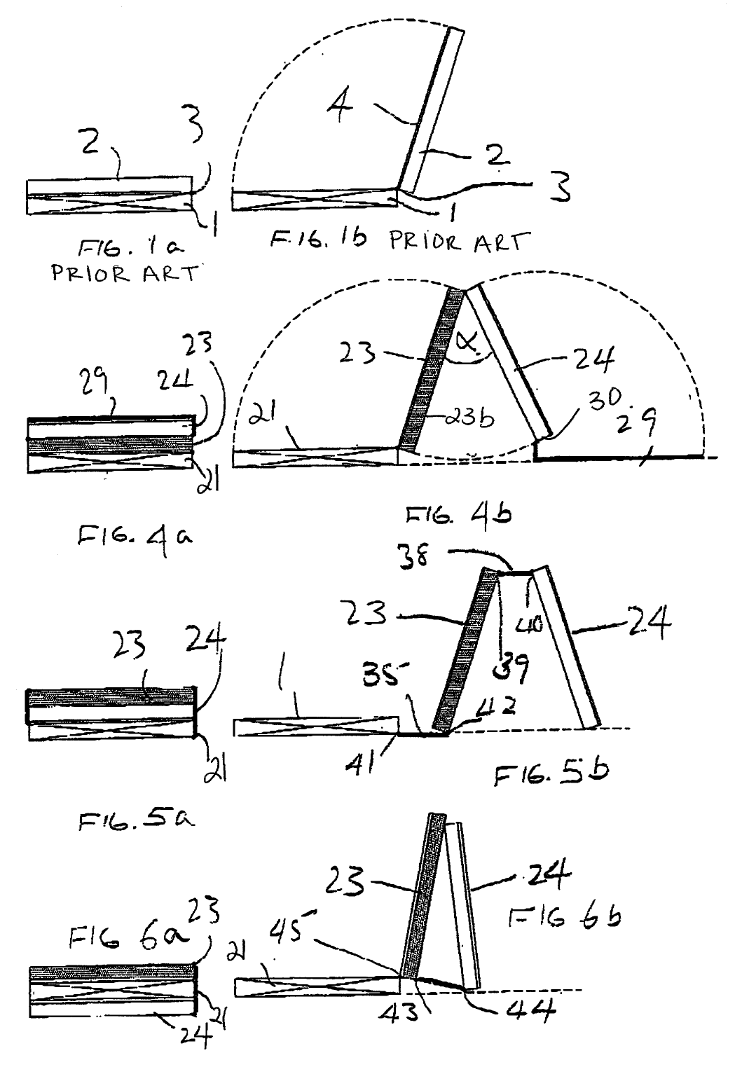

Referring to FIGS. 1a and 1b, the standard prior art laptop computer comprises a base 1 and lid 2. The base usually houses the keyboard and most of the computer circuitry and any ancillary devices such as a floppy disc reader/writer and CD-rom reader and the lid 2 houses the display 4. The base 1 and lid 2 are pivotally connected together by hinges 3 which enable the lid 2 to be placed in any suitable angular position relative to the base 1 for ease of viewing the screen of the display in the lid. When closed, as shown in FIG. 1a, the display 4 faces the base 1 and is protected by the lid 2 of the computer.

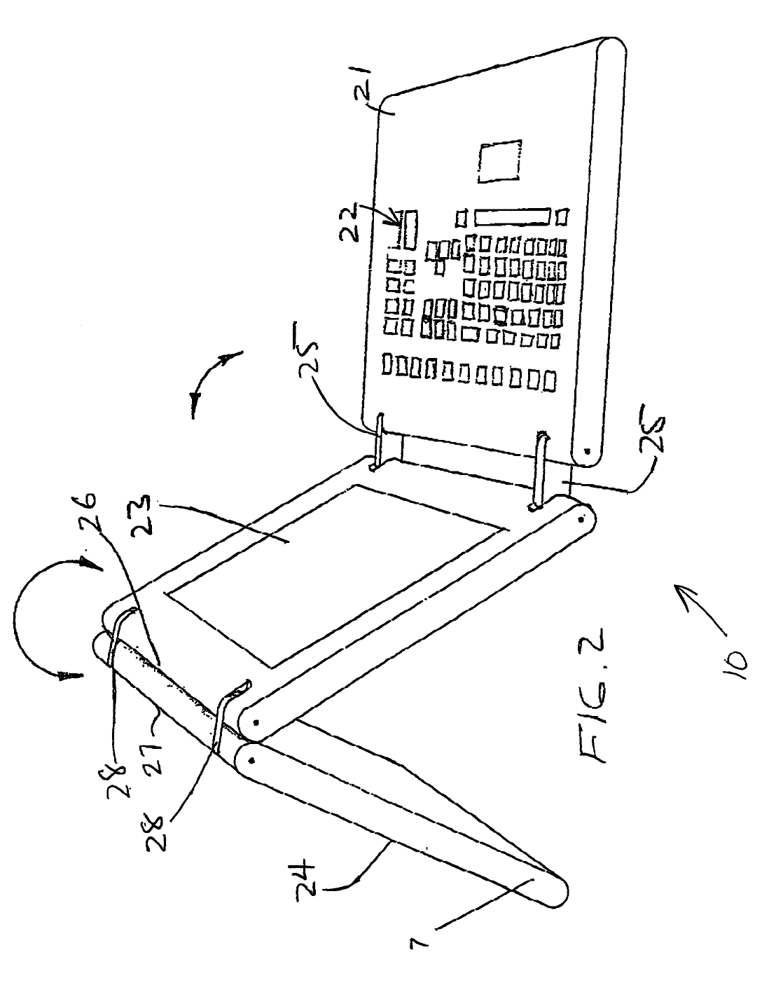

Referring now to FIGS. 2 and 3, a laptop computer 10 according to the present invention includes a base 21 which houses the keyboard 22, circuitry and ancillary devices already mentioned and known in the art. There is also a first display 23 and a second display 24. The first display 23 is pivotally connected to the base 21 by means of a cable way containing extended or long hinges 25 through which electrical connections between the circuitry in the base 21 and the display 23 are made. The first display 23 is also pivotally connected at its upper edge 26 to the upper edge 27 of the second display 24. The connection preferably includes two shorter hinges 28 which provide a cableway through which electrical connections between the two displays are made. The hinges 25 need only permit the base and first display 23 to rotate through about 180° with respect to each other, whereas the hinges 28 preferably permit the first and second displays 23 and 24 to rotate through more than about 270°, with respect to each other.

FIG. 2 shows the computer in the open or operative position, with the displays adopting an inverted V-shape. In this position, the computer operator would normally sit at the keyboard 22 with the first display 23 directly in front of the operator, whilst the customer/associate would sit opposite with the second display 24 directly in front. In this way, the operator would be able to control the content of both displays and both the operator and the customer/associate would have a clear view of the information displayed on the respective screens. If desired, the displays could display the same information, or the information could differ between the first and second display. This is a much more comfortable and satisfactory arrangement then having to rely upon an arrangement with a single display where it is difficult for both customer/associate and operator to see the single screen clearly together, and where it may even be necessary to move the display between customer/associate and operator. It will be appreciated that both displays may be adjusted, as desired, to give the best viewing angle. In the position shown in FIG. 2, both displays are disposed at approximately 60° to the horizontal plane, with the base 21 of the computer resting on the horizontal plane. This angle can be adjusted by pivoting the first display 23 in relation to the base 21, and the second display 24 in relation to the first display 23. Different viewing angles may be chosen for the displays by having the displays at different angles to the horizontal plane. This may mean that the second display 24 may be supported only by hinges 28 or, if necessary, a support under the lower edge of the second display 24 on the surface on which the computer is supported may also be provided.

To close the computer, the second display 24 is rotated relative to the first display 23 through an angle of more than about 270° until the screens of the displays 24 and 23 are aligned facing each other, and therefore protected. The two displays together may then be pivoted with respect to base 21 onto the keyboard 22 into the fully closed or stored position shown in FIG. 3.

Referring now to FIGS. 4a and 4b, a second embodiment is diagrammatically shown. In this embodiment the two displays 23 and 24 are pivotally connected together and to the base 21 substantially as described before with respect to FIGS. 2 and 3. The displays 23, 24 also adopt similar open positions (as shown in FIG. 4b) but the manner in which they are pivoted to the closed position (as shown in FIG. 4a) differs. Further, a protective cover 29 is provided which is pivotally connected to the lower edge 30 of the second display 24, and which in the open position preferably provides a support for both displays 23 and 24. When closing from the open position as shown in FIG. 4b to the closed position shown in FIG. 4a, the cover 29 is placed over the display 24 to protect its screen, and this assembly is pivoted through the acute angle α in contact with the back 23b of the first display 23. The first and second displays 23, 24 and cover 29 may then be pivoted to cover the base 21, where the screen of the first display 23 covers the keyboard side of the base 21, in the position shown in FIG. 4a. In this manner, both display screens are also protected.

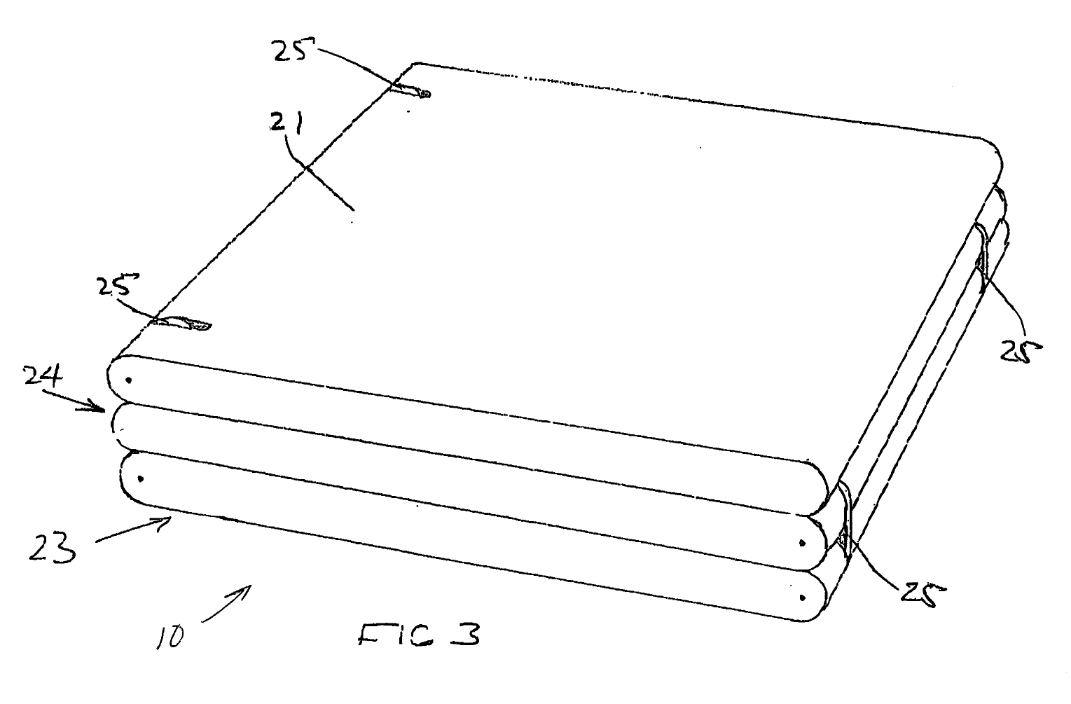

FIGS. 5a and 5b diagrammatically show a third embodiment in the closed and open positions respectively. In this embodiment hinges 35 and 38 pivotally connect the base 21 to the first display 23, and connect displays 23 and 24 together, respectively. The hinges 35, 38 permit the displays and base to be pivoted together in a manner similar to the embodiment of FIGS. 2 and 3, but with the displays 23, 24 being further laterally displaced from one another when in the open operative positions. Likewise, the base 21 and first display may be laterally displaced. For this purpose, the hinges 38 are pivotally connected to those edges 39, 40 of displays 23 and 24 which are adjacent in the open position. Hinges 35 are pivotally connected between the lower edges 41 of the base and the lower edge 42 of display 23. This embodiment is closed in the same manner as the embodiment of FIGS. 2 and 3.

FIGS. 6a and 6b diagrammatically show a fourth embodiment in the closed and open positions, respectively. In this embodiment first and second displays 23 and 24 are pivotally connected together at adjacent lower edges 43 and 44, and the other lower edges of the first display 23 is pivotally connected to the adjacent upper edge 45 of the base 21. In moving from the open position of FIG. 6b to the closed position of FIG. 6a, the second display 24 is pivoted to one side of the base 21 and the first display 23 to the other, so that the base 21 is sandwiched between the two displays 23 and 24, with the screens of the displays facing inwards towards the base 21, and therefore protected.

It will be understood that various modifications may be made to the embodiment disclosed herein. Therefore, the above description should not be construed as limiting, but merely as exemplifications of a preferred embodiment. Those skilled in the art will envision other modifications within the scope spirit of the invention.

1. A computer comprising:
a base;
a display arrangement having a first display including a screen, and a second display including a screen;
means for pivotally connecting the first display to the second display, and for connecting the display arrangement to the base; and
wherein the means for pivotally connecting are arranged to permit the first and second displays to be pivoted from a closed position in which the display screens are protected by the base, to an open position in which the display screens face away from each other.

2. The computer as recited in claim 1, wherein the means for pivotally connecting comprises two or more hinges constructed and arranged to connect the first display to the second display, and the display arrangement to the base.

3. The computer as recited in claim 2, wherein the hinges are disposed between adjacent edges of the first and second displays, and between another edge of the first display and one edge of the base.

4. The computer as recited in claim 3, wherein the hinges disposed between adjacent edges of the first and second displays permit the first and second displays to adopt an inverted V-shape in an open position.

5. The computer as recited in claim 4, wherein the hinges are disposed at an apex of the V in the open position.

6. The computer as recited in claim 5, wherein the hinges are constructed and arranged to permit the second display to be rotated more than half a rotation from an operative position to bring it into line with the first display.

7. The computer as recited in claim 5, wherein the hinges are constructed and arranged to permit the second display to be rotated less than half a rotation from an operative position to bring it into line with the first display.

8. The computer as recited in claim 7, further comprising a protective cover constructed and arranged to cover the screen of the second display when in a closed position.

9. The computer as recited in claim 8, wherein the protective cover is pivotally connected to the second display and is operative to provide a support for the displays in the open position during use.

10. The computer as recited in claim 2, wherein the hinges comprise a cableway including extended hinges constructed and arranged to house electrical connections between the base and the first and second displays.

11. A computer comprising:
a base;
a display arrangement having a first display including a screen, and a second display including a screen;
a first member constructed and arranged to pivotally connect the first display to the second display;
a second member constructed and arranged to pivotally connect the display arrangement to the base; and
wherein the first and second members permit the first and second displays to be pivoted from a closed position in which the display screens are aligned with the base, to an open position in which the display screens face away from each other.

12. The computer as recited in claim 11, wherein the first member comprises two or more hinges, and the second member comprises two or more hinges.

13. The computer as recited in claim 12, wherein the hinges of the first member are disposed between adjacent edges of the first and second displays, and wherein the hinges of the second member are disposed between another edge of the first display and one edge of the base.

14. The computer as recited in claim 13, wherein the hinges of the first member disposed between adjacent edges of the first and second displays permit the first and second displays to adopt an inverted V-shape in an open position.

15. The computer as recited in claim 14, wherein the hinges of the first member are disposed at an apex of the V in the open position.

16. The computer as recited in claim 15, wherein the hinges of the first member are constructed and arranged to permit the second display to be rotated more than half a rotation from an operative position to bring it into line with the first display.

17. The computer as recited in claim 15, wherein the hinges of the first member are constructed and arranged to permit the second display to be rotated less than half a rotation from an operative position to bring it into line with the first display.

18. The computer as recited in claim 17, further comprising a protective cover constructed and arranged to cover the screen of the second display when in a closed position.

19. The computer as recited in claim 18, wherein the protective cover is pivotally connected to the second display and is operative to provide a support for the displays in the open position during use.

20. The computer as recited in claim 12, wherein the hinges of the second member comprise a cableway including extended hinges constructed and arranged to house electrical connections between the base and the first and second displays.
